(19) United States
(12) Patent Application Publication
(10) Pub. No.: US 2026/0219916 A1
(43) Pub. Date: Jul. 30, 2026

(54) METHODS AND SYSTEMS FOR EXECUTION AND MANAGEMENT OF SOFTWARE AND DATA IN A CLOUD ENVIRONMENT

(71) Applicant: VANDERBILT UNIVERSITY, Nashville, TN (US)

(72) Inventors: David A. B. HYDE, Nashville, TN (US); Ravindra DUDDU, Nashville, TN (US)

(21) Appl. No.: 19/158,361

(22) PCT Filed: Jan. 19, 2024
(86) PCT No.: PCT/US2024/012157

§ 371 Date: Aug. 20, 2025

Related U.S. Application Data
(60) Provisional application No. 63/486,629, filed on Feb. 23, 2023.

(51) Int. Cl. G06F 9/455; G06F 8/60

(52) U.S. Cl. CPC G06F 9/45558; G06F 8/60; G06F 2009/45595

(57) ABSTRACT

A cloud-native platform facilitates the main components of a scientific computing workflow, The platform provides the execution of physics-based simulation software in a cloud-computing environment. The platform provides an accessible interface 2024/177751 to users, such as geoscientists, to run software and data analysis tools in the cloud without requiring cloud computing expertise. The platform includes a cloud-based backend including one or more application programming interfaces (APIs), one or more cloud provider compute nodes, and cloud provider storage. Users access the platform via a command-line utility or graphical user interface on their computing device which enables them to run simulation software, incorporate new data, update code, store and organize results, visualize results, and share code and results data publicly or with other users of the platform.

### FIELD OF THE DISCLOSURE

This disclosure relates to the fields of networked systems, cloud computing, computational science, data visualization, and collaboration.

### BACKGROUND

The rise of cloud-based computing architectures has enabled transformations in the scale and capabilities of online sites and services, from streaming music, to ecommerce, and to enterprise software. A cloud-based architecture involves deploying or renting a set of hosted computational resources, such as processors, storage, software, and other components, which comprise virtual machines or other systems that perform computation. Users can rent the resources and virtual machines needed to run their applications, e.g., an online storefront, and typically this usage can be billed in small time increments like hours or days. Users typically interact with cloud computing providers via a centralized management system or server. Cloud computing resources may be available via public providers, or alternatively, private data centers may offer their computational infrastructure to internal users in a similar manner.

Cloud computing is also used for scientific, research, and analytics applications. For example, a scientist may have physics simulation software with which they wish to simulate a complex natural phenomenon. The scientist may only have limited computational resources locally available to them; therefore, they may seek to use the massive amount of available computing power in the cloud to run their code. Typically, the usage of the cloud in these use cases requires first learning the concepts of cloud computing; then learning the terminology and interfaces associated with a particular cloud computing provider; then manually transferring software and any necessary data to the cloud; then instantiating and manually interacting with virtual machines to run the software as needed; then downloading the results or output from the software in order to perform analysis; and finally, manually deprovisioning cloud infrastructure in order to stop being billed once the software has finished running. At each step of the process, computational and/or cloud computing expertise is required, which scientists may not possess a priori, and there is a significant amount of manual interaction and processing. Moreover, there are many ways to optimize performance of scientific software in the cloud, such as selecting virtual machine instance types with hardware that is suited for the application being run (e.g., machines with graphics processing units (GPUs) for applications written in the Compute Unified Device Architecture (CUDA) language) and automatically load balancing even in the face of straggler nodes that typically hinder cloud computing performance (cf. Shah et al., Comp. Graph. Forum (2018) 37:8 35-46 doi: 10.1111/cgf.13510, which is incorporated by reference here in its entirety). The time and effort that is necessary to acquire the knowledge required to use—and to optimize the usage of—cloud computing for scientific software and data applications is costly and/or prohibitive for users.

Therefore, there is a dearth of, and commercial utility for, systems and methods that facilitate the usage of cloud computing architectures and platforms without requiring expert knowledge. There is an associated need for the design of standardized interfaces, methods, and formats for users to interact with such systems. There is an associated need for both command-line and graphical user interfaces that allow users to leverage cloud computing resources without such expert knowledge. There is an associated need for systems, methods, and interfaces that automatically optimize the execution of scientific software and analysis tools in cloud environments. There is an associated need for systems and interfaces that allow users to analyze and share data and software with other users or guests of the system. There is an associated need to provide interfaces that allow users to easily review logs of software being run via the system. There is an associated need to enable users to leverage cloud computing without regard to any vendor's offerings or terminologies. To achieve these goals, there is the implicit need for software and hardware architectures and methodologies that enable such developments.

### SUMMARY

The disclosure provides systems and methods for the execution and management of software and data in a cloud environment. Specifically, the disclosure provides computer network infrastructure designs, software methods, and interfaces that enable designers and users of scientific, data analysis, and visualization software to easily deploy and run their software in public or private cloud environments, without specialized expertise in cloud computing. The disclosure includes user interface designs to facilitate usage of cloud computing resources by non-experts. Techniques for automatically optimizing the execution of software deployed in the cloud are also disclosed as part of the present disclosure. Furthermore, the disclosure enables noteworthy collaboration and sharing features that facilitate open science and address the reproducibility crisis. The present disclosure overcomes the limitations of the prior art by providing, in one aspect, the design of a multi-cloud platform that enables users without cloud computing expertise to easily run their software, application, and analysis tasks using cloud computing resources. The disclosure includes: the design of standardized interfaces, methods, and formats for participants to interact with the system; command-line and graphical user interfaces that facilitate simple usage of cloud computing resources; architecture and processes that enable running arbitrary computational workloads supplied by users; interfaces and systems for sharing software and data via the platform; and techniques for optimizing the execution of workloads run via the platform. One skilled in the art will readily recognize that any computational infrastructure described herein could be deployed via a public cloud provider, via a private data center or supercomputing environment, via a local computer, or via any other hosted or on-premises means by which software is deployed (including using virtualization techniques like virtual machines and Docker).

Other aspects include components, devices, systems, improvements, methods, processes, applications, computer readable mediums, and other technologies related to any of the above.

### BRIEF DESCRIPTION OF THE DRAWINGS

Embodiments of the disclosure have other advantages and features which will be more readily apparent from the following detailed description and the appended claims, when taken in conjunction with the accompanying drawings, in which:

FIG. 1 is a schematic diagram of one embodiment of the architecture and system, including certain related infrastructure components, described in accordance with one or more embodiments of the disclosure. FIG. 1 includes how a user may interact with the system to run software via the system.

FIG. 2 is a schematic diagram demonstrating one embodiment of how a user might avail themselves of additional features of the architecture and system, including certain related infrastructure components, described in accordance with one or more embodiments of the disclosure.

FIG. 3 is a schematic diagram depicting how program inputs and outputs flow through the architecture and system, described in accordance with one or more embodiments of the disclosure. FIG. 3 may be associated with user workflows as depicted in FIG. 1 and FIG. 2.

FIG. 4 is a schematic diagram depicting one embodiment of the command-line interface for utilizing the system.

FIG. 5 is a schematic diagram depicting one embodiment of an architecture of a system for execution and management of software and data in a cloud environment of the disclosure.

FIG. 6A depicts a perspective view of a one embodiment of a visualization generated by a system and method for execution and management of software and data in a cloud environment of the disclosure.

FIG. 6B depicts a perspective view of a user viewing a visualization generated by a system and method for execution and management of software and data in a cloud environment of the disclosure.

FIG. 6C depicts a perspective view of a one embodiment of a visualization generated by a system and method for execution and management of software and data in a cloud environment of the disclosure.

FIG. 6D depicts a perspective view of a one embodiment of a visualization generated by a system and method for execution and management of software and data in a cloud environment of the disclosure.

The same reference numerals in the drawings correspond to equivalent or identical parts appearing in the different drawings. The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION OF THE DRAWINGS

In some embodiments of the disclosed technology, an advanced cloud-based data and visualization integrated simulation environment (ADVISER) is provided. Additionally, the disclosed technology may be used to reduce computational burden by leveraging cloud-based environments to advance scientific research. For example, the disclosed technology may democratize the power of cloud computing to simplify access to leverage high-performance computing resources. In one example embodiment, ADVISER may be used to advance computational geosciences (e.g., glaciology). In this example, ADVISER may be used to democratize access to a software package for modeling the flow of glaciers and ice sheets. Additionally, the software package may be a user-friendly and open-source software package. In this example, access to the software package described herein provides advanced process-based modeling in geoscience fields, such as the field of glaciology.

The disclosed technology addresses at least three critical barriers to open science, as it specifically relates to computational glaciology and extends to computational geosciences more broadly: 1) Knowledge barriers, 2) Technology barriers, and 3) Education/Access barriers.

### 1) Knowledge Barriers

Despite the sophistication of existing cyberinfrastructure capabilities (e.g., ice sheet system models and data products with remote sensing and satellite observations), prior art systems lack a full understanding of which data is or is not important to initialize a particular ice sheet model parameter/variable. Additionally, or alternatively, prior art systems do not to devise parameterizations that adequately resolve the underlying physical processes. For example, there are several ice shelf and glacier processes related to surface and subglacial hydrology, fracture and calving, and basal frictional slip, which are currently poorly initialized and/or parameterized in ice sheet models.

### 2) Technology Barriers

Despite the emergence of cloud-based data repositories (e.g., CryoCloud, Ghub) and simulation environments (e.g., VESL), there are no standard frameworks or best practices for running simulations in the cloud. From the specifics of cloud providers'offerings to higher-level concerns such as load balancing in the face of stragglers or failing compute nodes, simulation code developers and users must reinvent the wheel each time they wish to deploy a new code to the cloud. Moreover, tasks like data visualization are bottlenecked by network transfer to and from cloud storage. Even storing data in the cloud is challenging, as one must have expertise in tiered storage offerings to minimize costs while maintaining performance. Overall, this has discouraged the use of cloud-based high-performance computing.

### 3) Education/Access Barriers

Typically, open-source simulation codes for ice dynamics modeling require a high level of expertise with the programming language, compilers, and computing architecture, despite extensive documentation and community support. Moreover, codes that have been deployed on supercomputers or in the cloud, still generally do not provide frameworks to easily integrate emerging data and visualize simulation results. These limitations inhibit the wider usage of these tools in research by scientists.

In some embodiments of the disclosed technology, the disclosed provides a platform to overcome the above three barriers in the context of computational geosciences. For example, the disclosed technology may be used in the context of computational glaciology. In some embodiments, a cloud computing platform (e.g., ADVISER) may be extended to integrate with an open-source software package. Further, a community of users may access the cloud computing platform, such as a team of scientists or the like, who may contribute to the platform and provide a sustainable open science ecosystem. The socialization and democratization of the platform may unfetter the broader community, such as early career researchers (e.g., undergraduate/graduate students). In this example, the platform enables users to hypothesize and develop new methods and algorithms for improving parameterization and initialization of large-scale data models (e.g., large-scale ice sheet models). By advancing modeling capabilities, the confidence in the data models and projected data models is enhanced. For example, the projections of future ice mass loss and/or global sea level rise. While the disclosed cloud computing platform is described in the context of glaciology, it is understood that the open science principles of the disclosed cloud computing platform are applicable across geosciences.

The figures and the following description relate to embodiments by way of illustration only. It should be noted that from the following discussion, alternative embodiments of the systems, structures, and methods disclosed herein will be readily recognized as viable alternatives that may be employed without departing from the principles of what is described or claimed.

In the following description, for purposes of explanation, numerous specific details are set forth to provide a thorough understanding of the disclosed concepts. As part of this description, some of this disclosure's drawings represent structures and devices in block diagram form to avoid obscuring the novel aspects of the disclosed embodiments. In this context, references to numbered drawing elements without associated identifiers (e.g., 100) refer to all instances of the drawing element with identifiers (e.g., 100a and 100b). Further, as part of this description, this disclosure's drawings may be provided in the form of a flow diagram. The boxes in any particular flow chart may be presented in a particular order. However, the particular flow of any flow diagram is used only to exemplify one embodiment. In other embodiments, any of the various components depicted in the flow chart may be deleted, or the components may be performed in a different order, or even concurrently. In addition, other embodiments may include additional steps not depicted as part of the flow chart. The language used in this disclosure has been principally selected for readability and instructional purposes and may not have been selected to delineate or circumscribe the disclosed subject matter. Reference in this disclosure to “one embodiment” or to “an embodiment” means that a particular feature, structure, or characteristic described in connection with the embodiment is included in at least one embodiment, and multiple references to “one embodiment” or to “an embodiment” should not be understood as necessarily all referring to the same embodiment or to different embodiments.

### Example Process Flow with a Physics Simulation Researcher

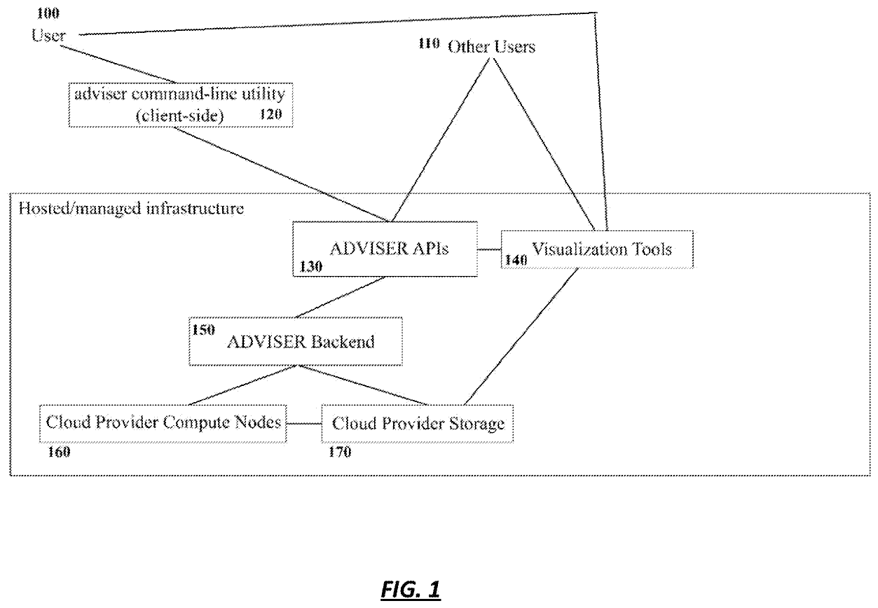

FIG. 1 is a schematic diagram of how a user may use and benefit from the disclosure (which, for ease of exposition, we call ADVISER or Adviser), including certain related infrastructure components, described in accordance with one or more embodiments of the disclosure. In the diagram, a user 100 has a copy of the Adviser command-line utility 120 on their computer or similar device. The user 100 may be a scientific researcher who has physics simulation code that they wish to run on the cloud; for instance, a three-dimensional (3D) fluid simulation of a waterfall. This fluid simulation code may be a command-line application that is invoked from a terminal or command prompt, as is typical for scientific software (though we later detail support for software with graphical interfaces as well). The user 100 enters a command to the utility 120 that they wish to be run in the cloud. The utility 120 then transmits information, software, and data from the user's device to an ADVISER backend 150 via ADVISER application programming interfaces (APIs) 130.

The computer or similar device used by User 100 may be a multifunctional device, such as a mobile phone, tablet computer, personal digital assistant, desktop PC, or the like.

The ADVISER backend 150 may contain sub-components, including servers, processors, storage, networking, and other related computational elements that would be apparent to a practitioner skilled in the art. Various components and functionality of the ADVISER backend 150 may be distributed across multiple network devices, such as servers, network storage, or the like. Further, additional components may be used, some combination of the functionality of any of the components may be combined. The ADVISER APIs 130 may perform input validation, rate limiting, IP filtering, logging, and other tasks associated with APIs that would be apparent to a practitioner skilled in the art.

Once the ADVISER backend 150 has a copy of the software and data used to run the user's desired software (including any flags or other information that the user supplied), the system then provisions cloud infrastructure used to run the software. This may include compute nodes 160 and storage 170 offered by one or multiple cloud providers (the user may optionally specify one or more cloud providers to use, or the system may select one by default). One skilled in the art would readily recognize that other cloud provider resources, such as networking, domain name system (DNS), load balancing, proxy, and other cloud provider resources may be provisioned to support the ultimate execution of the software on compute nodes. Notably, scientific software, like fluid simulation codes, are often parallel, and as such, there may be several compute nodes 160 involved in performing the task specified by the user; in such a case, additional infrastructure (such as auto scaling groups) related to coordinating the nodes involved in performing the computational work may be provisioned.

Once the cloud infrastructure is automatically provisioned, the ADVISER backend 150 transmits software and data to each of the compute nodes 160 involved in the task. In the case where multiple compute nodes are used, each compute node may only use some parts of the software or data, and the ADVISER backend may automatically partition these software or data. As the computational work is run on the compute nodes 160, output is ultimately saved to cloud provider storage 170. In the case of a 3D fluid simulation, output may include binary files that specify fluid mass at different points in space, text files that indicate error over time, or many other textual, visual, or binary data that is common to graphics and simulation programs.

The user 100 would then query ADVISER APIs 130 in order to access the outputs of their software run, which are stored in cloud provider storage 170. They may transfer these to their computer or other device, and if they do not access the data for a sufficiently long period of time (e.g., one day), the ADVISER backend 150 may automatically move the outputs to a cheaper and slower cloud storage solution (i.e., from hot storage to cold storage, though there may be more than two layers of tiered storage).

In some embodiments, the user 100 may also interact with their data without having to download any of the results. For instance, the system may have visualization software 140 pre-installed on cloud compute nodes, and that software may connect to cloud provider storage 170 and be made accessible via ADVISER APIs 130 or directly to the user 100 (even though this is not indicated in FIG. 1, this connection should be clear to one skilled in the art). In the example process of one embodiment, a user may run a scientific visualization or animation software like ParaView or Blender to create rendered animations of a waterfall simulation. Visualization or analysis software 140 may also be supplied by the user 100 as opposed to being built into the system, and such software may also be uploaded via ADVISER APIs 130. Visualization and analysis software 140 may be rendered to users 100 via techniques like server-side rendering and streaming of frames or may use other remote desktop protocols. Visualization and analysis software 140 may also reside on a user's computer or device and connect to cloud provider storage 170 directly or via APIs 130, rather than software and data both residing in the cloud.

Other users 110 may interact with the system in various ways. For instance, a user 100 may choose to publish data, output, analysis or visualization results, software, source code, documentation, or other associated materials (which would be apparent to a practitioner skilled in the art). Other users 110, who may or may not be registered with the system, would be able to access this information directly (such as running visualization or analytics software 140 on a shared dataset) or via APIs 130. Users 100 may set fine-grained permissions on one or more shared resources, e.g., restricting access to users in certain organizations, or with certain email addresses, or with certain geographical regions, etc.

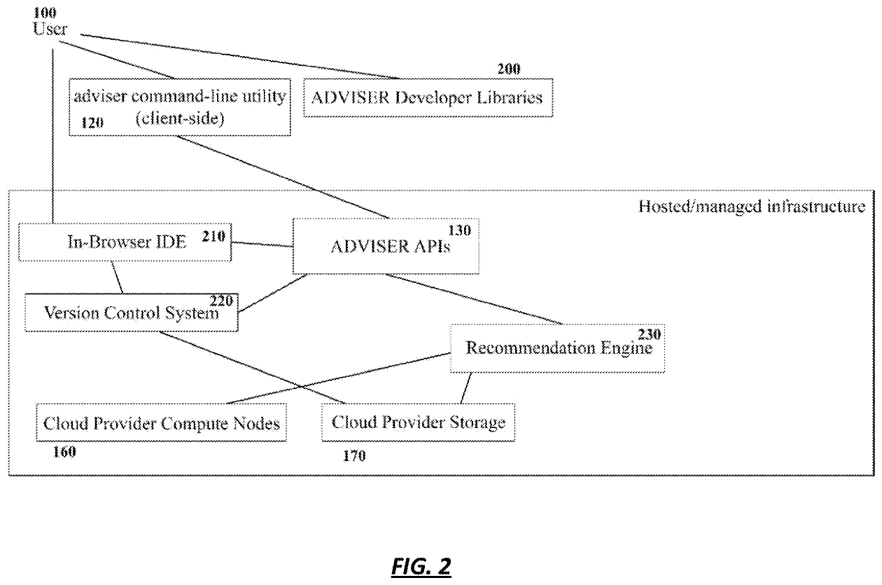

FIG. 2 depicts additional methods, systems, and interfaces that may exist within embodiments of the disclosure. For instance, the system may provide developer libraries 200 that aid the user 100 in creating software that runs efficiently within the platform. These libraries 200 may contain functionality like task execution graphs to aid with load balancing, annotations that help indicate which parts of a program could run on accelerators like GPUs, or domain-specific utilities and functionality (such as constitutive material models used in physics simulation software).

To facilitate development of software, the system may also include an in-browser integrated development environment (IDE) 210, which allows users 100 to modify and compile their code with one or more files and binaries being saved directly in cloud provider storage 170. This may eliminate the need for users 100 to transfer software and source code between their local computers and the cloud system.

Relatedly, the system may include a version control system 220 that facilitates managing changes to and collaboration on code that is stored in the system. This version control system 220 could, in one embodiment, be synchronized with a version control system on a user's local computer or device, whereby when a user makes changes to code on their local device, those changes are automatically transmitted to the ADVISER backend 150 including the version control system 220. In this way, the system allows for incremental updates to code stored in the cloud, rather than (for instance) having to retransmit all source code every time a user wants to run a new version of their software in the cloud.

A recommendation engine 230 may also serve as a component of the ADVISER backend 150. The recommendation engine 230 may use static analysis, artificial intelligence, or other related analytical and statistical techniques (which would be apparent to one skilled in the art) to optimize the execution of software in the system and using cloud provider resources. For instance, the engine 230 may identify a particular software executable as being capable of using accelerators like GPUs, and accordingly, the engine would select GPU-equipped cloud compute node 160 instance types. Similarly, the engine 230 may identify that the software may scale linearly up to 16 cores but sub-linearly after 16 cores and might accordingly select compute nodes 160 with 16 cores per node. The engine 230 may also dispatch multiple instances of a particular software with varied parameters (such as resolution) to gather more information for building statistical and learning models about optimizing execution of software within the system. The engine 230 may also estimate costs of running software on various cloud providers and select a cloud provider that may execute a given task with minimal total cost. The engine 230 may also analyze a user's past usage and determine, for example, whether software outputs should directly be written to cheaper cold storage as opposed to first being written to faster and more expensive cloud storage.

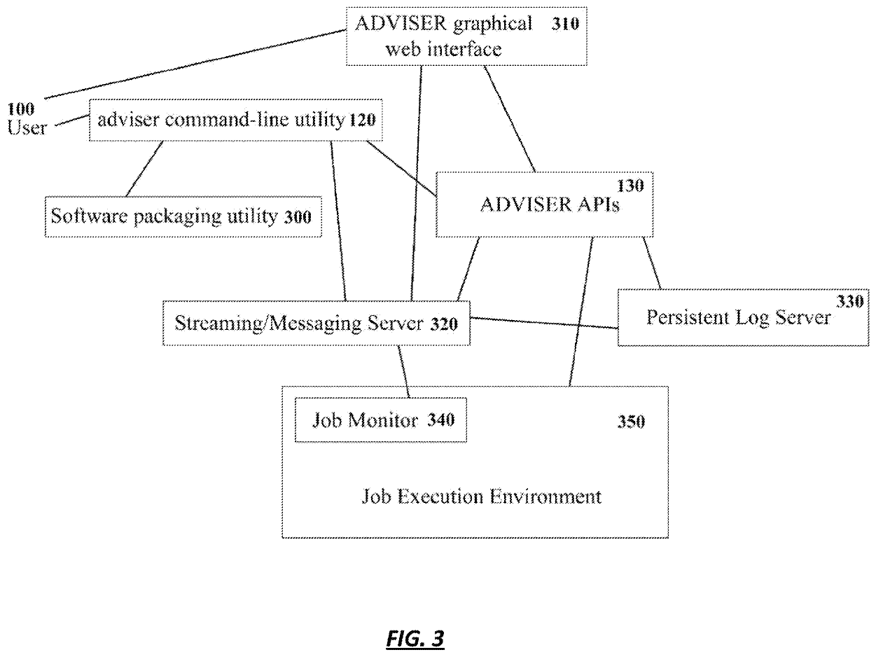

FIG. 3 provides additional clarity on how information flows through an embodiment of the disclosure. When a user 100 submits a software job to be run in the cloud via the systems and methods of the disclosure, the Adviser command-line utility 120 may, in one instance, run a software packaging utility 300 that generates a Docker container or other virtualized container or machine image that contains software and data used to run the software in the cloud. The software packaging utility 300 may, in an alternative embodiment, compress source code for a given target software into a zip file or other compressed file or archive, with that file or archive then being transmitted to the ADVISER backend 150 and/or version control system 220.

The ADVISER APIs 130 and backend 150 then coordinate the deployment of the software (compiling if necessary) to a job execution environment 350, and subsequently running the software in that environment. The job execution environment 350 may comprise compute nodes 160, cloud storage 170, and other infrastructure used to support the execution of the user's software. In one embodiment, the job execution environment 350 contains job monitors 340, which are software that collect streaming output from software as it is run in the execution environment 350. For instance, a job monitor 340 may capture the standard output and standard error streams from a command-line program being run in the job execution environment 350. The job monitor 340 forwards collected information in real-time to a streaming or messaging server 320. This server 320 could be implemented with any number of pub/sub, message queue, or event-based software systems, and could be run in another cloud or another data center. The streaming/messaging server 320 connects to the Adviser command-line utility 120 either directly or via ADVISER APIs 130. The command-line utility 120 is able to read data that is written to the messaging server 320 in real-time and print out that data to the user's computer or device. In this way, the user 100 sees outputs, errors, and other streams from their software in their terminal just as if the software is being executed locally, even though the software is actually being run in the cloud.

Logs and related textual output from the execution of the software may be stored from the streaming/messaging server 320 to a persistent log store 330 for future use, e.g., if the user wishes to go back and see what errors occurred in previous runs of their software.

A user 100 may perform interactions with the system, such as submitting jobs, managing running jobs, viewing results, etc., via a graphical web interface 310. The graphical web interface 310 behaves similarly to the Adviser command-line utility 120. In some embodiments, a user 100 may be enabled to provide, or publish, data using one-click sharing/publishing. For example, user 100 may publish software, datasets, results (e.g., visualizations), or a combination thereof, using a one-click sharing/publishing feature. In some embodiments, user 100 may immediately publish software/data/results on the platform by entering a single command via the command-line tool or selecting a button via the graphical user interface described here. Additionally, user 100 may be provided with various options to immediately publish software/data/results on the platform. Publishing may include automatically creating a public webpage with information about the shared resources and links to download them. User 100 may send the link to a webpage to one or more collaborators to advertise their work and/or share their resources with others. Additionally, or alternatively, user 100 may publish software/data/results to one or more project pages, for papers (e.g., academic research papers), for data repositories (e.g., government regulatory repositories), or the like. It is advantageous to do this via the cloud computing platform since all the software/data/etc. is already hosted there when user 100 wants to publish/share. In some embodiments, published data, such as software code or data results, may be assigned a unique identifier for versioning purposes. For example, a software program run on the cloud computing platform may be assigned a unique identifier and stored on the platform for historical purposes. Additionally, the cloud computing platform may store information about the environment in which the software program was originally executed, such as operating system version and versions of various software libraries. In one embodiment, such information may be stored in a text document (e.g., a Dockerfile) or other container or virtual machine file format. Thus, in the event that data needs to be re-created, a virtual machine may be implemented to execute the software program in the same environment the software program was originally executed.

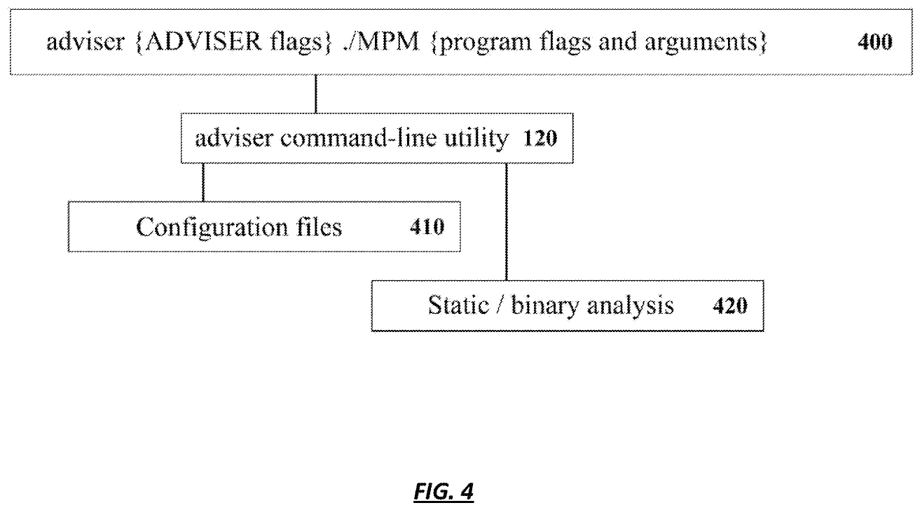

FIG. 4 depicts an example of a standardized interface for specifying how software is to be run in the system, which exemplifies the simplicity of the interface for users who lack cloud computing expertise. A user enters a command like the command 400 into their terminal or command prompt environment on their computer or local device. In the example depicted in FIG. 4, the user invokes the command-line utility 120 (e.g., Adviser) to run a scientific software program (e.g., MPM) that is located in the user's current working directory. One feature of the interface is that, in some cases, only one or two extra words are required to run software in the cloud-namely, prefixing the user's command with the name of the Adviser command-line utility 120 (e.g., “Adviser run” or “Adviser run-”). The command-line utility 120 also supports various flags, such as specifying a particular instance type of cloud computing nodes 160 to use that may be specified as seen in the example command 400. These flags and options may also be specified via one or more configuration files 410, such as a system-wide configuration file for the command-line utility 120 or a local configuration file that specifies values to use for programs run from the current working directory. Program arguments and flags may be specified in the usual way, as depicted in the example command 400. In another embodiment, the example command 400 involves separating command-line utility 120 and software flags and arguments with “--” or some other text character(s) in order to delineate the two sets of potential flags and arguments.

In some embodiments, the command-line utility 120 may rely on configuration files 410 to provide information like a user's credentials for authenticating to the platform; other common configuration file contents would be apparent to a practitioner skilled in the art. The utility 120 may also perform analysis like static analysis 420 on the software that is to be run in the cloud. This local analysis 420 may help inform the recommendation engine 230 and ADVISER backend 150 on the optimal ways to run the software in the cloud.

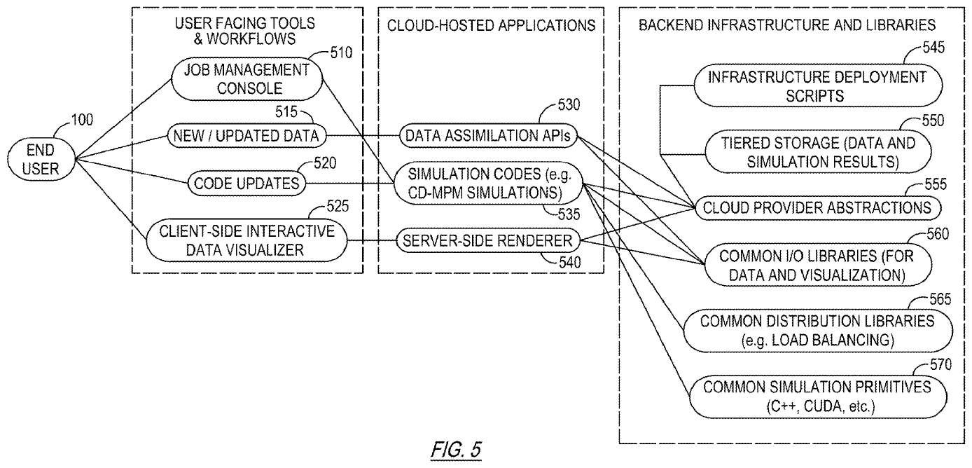

FIG. 5 depicts one embodiment of an architecture of the systems and methods disclosed herein. As can be seen from FIG. 5, the architecture may include three sections: user-facing tools and workflows, cloud-hosted applications, and backend infrastructure and libraries. One or more portions of these sections may be implemented, executed, or hosted on the user's 100 local computer, and one or more portions of these sections may be implemented, executed, or hosted on the hosted/managed infrastructure. The architecture of FIG. 5 may include portions of one or more components described above in relation to FIGS. 1-4.

The user-facing tools and workflows may include a job management console 510, new/updated data 515, code updates 520, and a client-side interactive data visualizer 525. The job management console 510 may form part of the advisor command-line utility 120, the ADVISER graphical web interface 310, the job monitor 340, or the job execution environment 350 of FIG. 3. The job management console 510 may include a user interface by which the user 100 may initiate or control the execution of one or more jobs in the ADVISER backend 150.

The new/updated data 515 may include new or updated data provided by the user 100 to the ADVISER backend 150 to be used in executing a job or software on the ADVISER backend 150. A code update 520 may include new or updated code or software to be executed by the ADVISER backend 150. The user-facing tools and workflows may include a client-side interactive data visualizer 525. The client-side interactive data visualizer 525 may form part of the visualization tools 140 and may include an interactive user interface by which the user 100 may view data used or generated by the ADVISER backend 150 and by which the user 100 may interact with such data.

In one embodiment, the cloud-hosted applications may include one or more data assimilation APIs 530, simulation codes 535, or a server-side renderer 540. The data assimilation APIs 530 may form part of the ADVISER APIs 130 and may receive data from the user 100 to be used by the software of the ADVISER backend 150. The simulation codes 535 may include software applications that may include simulations, for example, the 3D fluid simulation disclosed above or other physics-based simulations. The server-side renderer 540 may form part of the visualization tools 140 and may create rendered animations as discussed above.

In some embodiments, the backend infrastructure and libraries may include infrastructure deployment scripts 545, tiered storage 550, cloud provider abstractions 555, input/output (I/O) libraries 560, distribution libraries 565, and simulation primitives 570. The infrastructure deployment scripts 545 may include software that controls the deployment of one or more jobs or cloud provider compute nodes 160. The infrastructure deployment scripts 545 may form part of the job monitor 340, the job execution environment 350, or other portions of the ADVISER backend 150. The tiered storage 550 may include data storage used by the ADVISER backend 150 and may store data or simulation results. The tiered storage 550 may form part of the cloud provider storage 170.

In some embodiments, the cloud provider abstracts 555 may include one or more data structures that store logical data objects that correspond to one or more pieces of hardware or software used in provisioning cloud resources of the ADVISER backend 150. The I/O libraries 560 may include one or more common software libraries that may include configuration data, software subroutines, or other prewritten data and software used by software executed on the ADVISER backend 150. An I/O library 560 may include a library for data or visualization. For example, an I/O library 560 may include a graphical library used by the client-side interactive data visualizer 525 or the server-side renderer 540 in displaying a graphical representation of a simulation. The distribution libraries 565 may include one or more common software libraries for distributing jobs or tasks among the ADVISER backend's 150 computing resources. For example, a distribution library 565 may include one or more load-balancing subroutines used in distributing jobs to the cloud provider compute nodes 160. The simulation primitives 570 may include one or more pieces of software that may execute or compile software code for use by the ADVISER backend 150. For example, a simulation primitive 570 may include a C++ compiler or CUDA API.

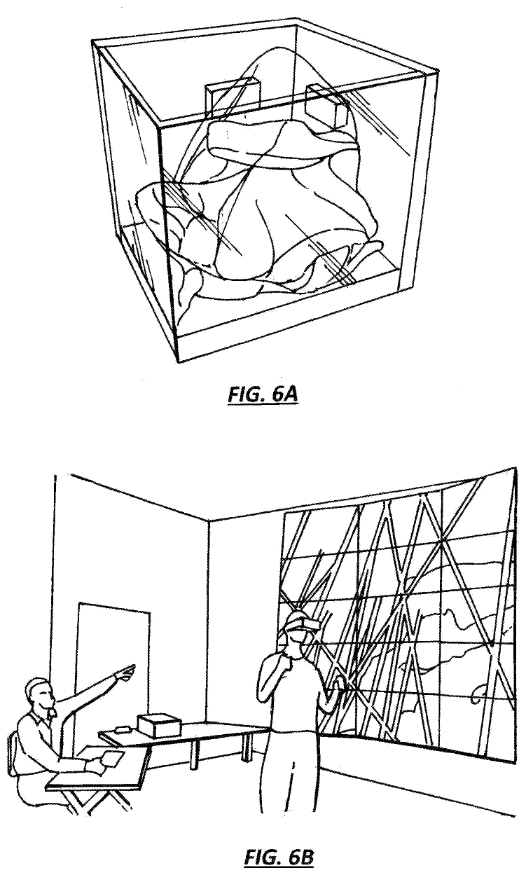

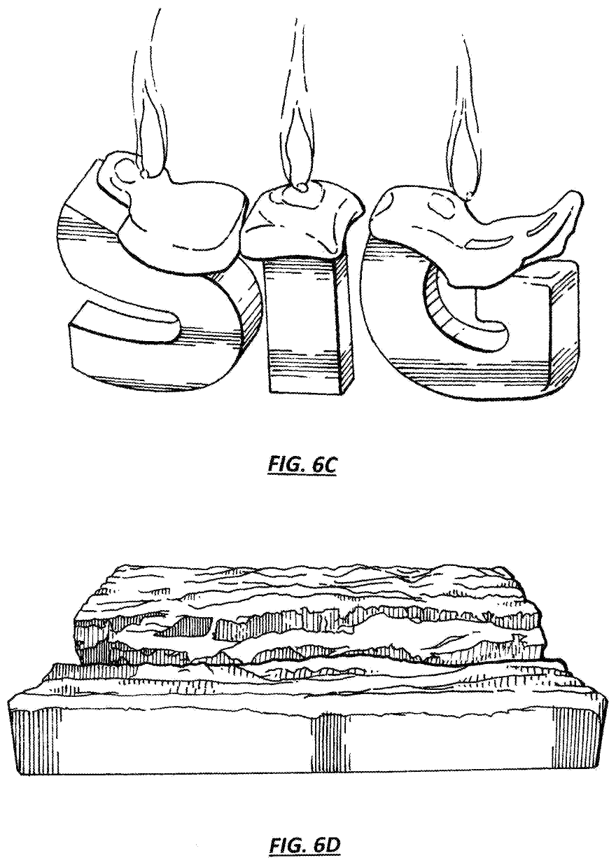

FIG. 6A depicts one embodiment of a 3D rendering of a fluid simulation. The user 100 may have provided the data and software to the ADVISER backend 150, and the ADVISER backend 150 may have executed the simulation based on such data. In one embodiment, the ADVISER backend 150 may include Google Cloud under a load-balancing framework. The visualization tools 140 may have generated the 3D rendering of FIG. 6A for display on the user's 100 computer. FIG. 6B depicts one embodiment of a user 100 viewing a 3D rendering that could be generated by the ADVISER backend 150 through a virtual reality (VR) headset. The 3D rendering may include an interactive 3D rendering that could be generated by the client-side interactive data visualizer 525. FIG. 6C depicts a 3D rendering of a physics simulation that could be executed by the ADVISER backend 150. In FIG. 6C, the simulation includes a multiphase thermodynamic MPM simulation. FIG. 6D depicts a 3D rendering of a physics simulation that could be executed by the ADVISER backend 150. In FIG. 6D, a glacial calving simulation using the continuum-damage material point method is shown.

Although the detailed description contains many specifics, these should not be construed as limiting the scope of the disclosure but merely as illustrating different examples and aspects of the disclosure. As such, it should be understood that the inclusion or discussion of a certain component, element, action, or step does not mean that such component, element, action, or step is required. Similarly, it should be appreciated that the scope of the disclosure includes other embodiments not discussed in detail above. For example, one may add a monitoring server into the architecture presented in FIG. 1 that gathers statistics about each of the components in the system. One may also add a component for administration of the system depicted in FIG. 1. One may also use the ADVISER graphical web interface 310 from FIG. 3 in one or more places the Adviser command-line utility 120 is used, e.g., in the flows described in FIG. 1 and FIG. 2. One may also connect the persistent log server 330 to the Adviser command-line utility 120 or ADVISER graphical web interface 310 directly as opposed to via the ADVISER APIs 130. Various other modifications, changes and variations which will be apparent to those skilled in the art may be made in the arrangement, operation and details of the method and apparatus of the present disclosure provided herein without departing from the spirit and scope of the disclosure.

Furthermore, while the above description sometimes references scientific software and data, the systems and methods of the disclosure are not limited to such types of software or data. For example, the systems and methods disclosed herein could be applied to a command-line tool that could execute on the ADVISER backend 150. The systems and methods could be applied to a business analytics processing workload or job. The systems and methods are also not limited to precompiled binary executables; for example, the systems and methods could be used to execute Jupyter notebooks written in Python, or similar notebook-and script-based codes via the ADVISER backend 150. The systems and methods provided could also enable real-time editing of such notebooks and scripts without requiring redeploying updated code or binaries to the server from the client's device. The systems and methods could execute on other types of software or data.

Reference throughout this specification to “one embodiment,” “an embodiment,” “another embodiment,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not necessarily all embodiments” unless expressly specified otherwise.

The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. As used herein, the term “a,” “an,” or “the” means “one or more” unless otherwise specified. The term “or” means “and/or” unless otherwise specified.

As used herein, the terms “computing device,” “computer,” “device,” and other similar terms may include a desktop computer, a laptop computer, a tablet computer, a mobile device such as a mobile phone or a smart phone, a smartwatch, a gaming console, an application server, a database server, or some other type of computing device. A computing device may include a physical computing device or may include a virtual machine (VM) executing on another computing device. A computing device may include a cloud computing system, a distributed computing system, or another type of multi-device system.

As used herein, the terms “data network,” “network,” and other similar terms may include a local area network (LAN), wide area network (WAN), the Internet, or some other network. A data network may include one or more routers, switches, repeaters, hubs, cables, or other data communication components. A data network may include a wired connection or a wireless connection.

As used herein, the terms “computing platform,” “platform,” “backend,” and other similar terms may include a computing environment where a portion of software may execute. A computing platform may include hardware on which the software may execute. The computing platform may include an operating system. The computing platform may include one or more software applications, scripts, functions, or other software. The computing platform may include one or more application programming interfaces (APIs) by which different portions of the software of the platform may communicate with each other or invoke functions. The computing platform may include one or more APIs by which it may communicate with external software applications or by which external software applications may interact with the platform. The computing platform may include a software framework. The computing platform may include one or more VMs. The software platform may include one or more data storages. The software platform may include a client application that executes on an external computing device and that interacts with the platform in a client-server architecture.

As used herein, the terms “data storage,” “storage,” or other similar terms may include a tangible device that retains and stores data. Such device may include an electronic storage device, a magnetic storage device, an optical storage device, an electromagnetic storage device, a semiconductor storage device, or any suitable combination of the foregoing. A non-exhaustive list of more specific examples of the devices may include a portable computer diskette, a random access memory (RAM), a read-only memory (ROM), an erasable programmable read-only memory (EPROM or flash memory), a static random access memory (SRAM), a hard disk drive (HDD), a solid state drive, a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. “Data storage,” in some embodiments, may include a data structure that stores data, and the data structure may be stored on a tangible data storage. Such data storage may include a file system, a database, cloud storage, a data warehouse, a data lake, or other data structures configured to store data.

As used herein, the terms “determine” or “determining” may include a variety of actions. For example, “determining” may include calculating, computing, processing, deriving, looking up (e.g., looking up in a table, a database or another data structure), ascertaining, or other actions. Also, “determining” may include receiving (e.g., receiving information or data), accessing (e.g., accessing data in a memory, data storage, distributed ledger, or over a network), or other actions. Also, “determining” may include resolving, selecting, choosing, establishing, or other similar actions.

As used herein, the terms “provide” or “providing” may include a variety of actions. For example, “providing” may include generating data, storing data in a location for later retrieval, transmitting data directly to a recipient, transmitting or storing a reference to data, or other actions. “Providing” may also include encoding, decoding, encrypting, decrypting, validating, verifying, or other actions.

As used herein, the term “access,” “accessing,” and other similar terms may include a variety of actions. For example, accessing data may include obtaining the data, examining the data, or retrieving the data. Providing access or providing data access may include providing confidentiality, integrity, or availability regarding the data.

As used herein, the term “message” and other similar terms may include one or more formats for communicating (e.g., transmitting or receiving) information or data. A message may include a machine-readable collection of information such as an Extensible Markup Language (XML) document, fixed-field message, comma-separated message, or another format. A message may, in some implementations, include a signal utilized to transmit one or more representations of information or data.

As used herein, the term “user interface” (also referred to as an interactive user interface, a graphical user interface or a UI), may refer to a computer-provided interface including data fields or other controls for receiving input signals or providing electronic information or for providing information to a user in response to received input signals. A user interface may be implemented, in whole or in part, using technologies such as hyper-text mark-up language (HTML), a programming language, web services, or rich site summary (RSS). In some implementations, a user interface may be included in a stand-alone client software application configured to communicate in accordance with one or more of the aspects described.

As used herein, the term “modify” or “modifying” may include several actions. For example, modifying data may include adding additional data or changing the already-existing data. As used herein, the term “obtain” or “obtaining” may also include several types of action. For example, obtaining data may include receiving data, generating data, designating data as a logical object, or other actions.

While the making and using of various embodiments of the present disclosure are discussed in detail herein, it should be appreciated that the present disclosure provides many applicable inventive concepts that are embodied in a wide variety of specific contexts. The specific embodiments discussed herein are merely illustrative of specific ways to make and use the disclosure and do not delimit the scope of the disclosure. Those of ordinary skill in the art will recognize numerous equivalents to the specific apparatuses, systems, and methods described herein. Such equivalents are considered to be within the scope of this disclosure and may be covered by the claims.

Furthermore, the described features, structures, or characteristics of the disclosure may be combined in any suitable manner in one or more embodiments. In the description contained herein, numerous specific details are provided, such as examples of programming, software, user selections, hardware, hardware circuits, hardware chips, or the like, to provide understanding of embodiments of the disclosure. One skilled in the relevant art will recognize, however, that the disclosure may be practiced without one or more of the specific details, or with other methods, components, materials, apparatuses, devices, systems, and so forth. In other instances, well-known structures, materials, or operations may not be shown or described in detail to avoid obscuring aspects of the disclosure.

These features and advantages of the embodiments will become more fully apparent from the description and appended claims or may be learned by the practice of embodiments as set forth herein. As will be appreciated by one skilled in the art, aspects of the present disclosure may be embodied as an apparatus, system, method, computer program product, or the like. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present disclosure may take the form of a computer program product embodied in one or more computer-readable media having program code embodied thereon.

In some embodiments, a module may be implemented as a hardware circuit comprising custom (very large-scale integration) VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer-readable media.

In some embodiments, a module may include a smart contract hosted on a blockchain. The functionality of the smart contract may be executed by a node (or peer) of the blockchain network. One or more inputs to the smart contract may be read or detected from one or more transactions stored on or referenced by the blockchain. The smart contract may output data based on the execution of the smart contract as one or more transactions to the blockchain. A smart contract may implement one or more methods or algorithms described herein.

The computer program product may include a computer-readable storage medium (or media) having computer-readable program instructions thereon for causing a processor to carry out aspects of the present disclosure. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein may be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, to perform aspects of the present disclosure.

Aspects of the present disclosure are described herein with reference to flowchart illustrations or block diagrams of methods, apparatuses, systems, algorithms, or computer program products according to embodiments of the disclosure. It will be understood that each block of the flowchart illustrations and/or block diagrams, and combinations of blocks in the flowchart illustrations and/or block diagrams, may be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that may direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

What is claimed is:

1. A system, comprising:
a cloud platform backend including one or more application programming interfaces (APIs), one or more cloud provider compute nodes, and cloud provider storage;
a user computing device in data communication with the cloud platform backend, the user computing device comprising a memory and one or more processors, wherein the user computing device is configured to:
provide at least one input interface to a user of the user computing device;
receive input from the user of the user computing device via the at least one input interface;
generate a virtualized container, including software and data, based on the input received from the user of the user computing device;
send the virtualized container to the one or more APIs of the cloud platform backend;
receive collected information from the one or more APIs of the cloud platform backend based on results generated by the one or more cloud provider compute nodes; and
display the collected information via a display of the user computing device.

2. The system of claim 1, wherein the cloud platform backend is configured to:
receive, at the one or more APIs, the virtualized container;
coordinate the deployment of the software to a job execution environment, including the one or more cloud provider compute nodes and the cloud provider storage;
execute the software of the virtualized container in the job execution environment;
capture standard output and standard error streams from a command-line program being run in the job execution environment;
forward the collected information in real-time to a streaming or messaging server, and
send, via the streaming/messaging server, the collected information to the user computing device.

3. The system of claim 2, wherein the execution of the software in the job execution environment comprises a physics simulation.

4. The system of claim 1, wherein the at least one input interface comprises a command-line utility.

5. The system of claim 1, wherein the at least one input interface comprises a graphical user interface.

6. The system of claim 1, wherein the command-line utility of the user device is further configured to view results of the execution of the software in the job execution environment.

7. The system of claim 1, wherein the user computing device is further configured to view the collected information in a graphic web interface.

8. A method for executing and managing software and data in a cloud environment, comprising:
receiving, at an application programming interface (API) of a cloud provider backend, a virtualized container, including software and data;
coordinating, on the cloud provider backend, the deployment of the software to a job execution environment, including one or more cloud provider compute nodes and cloud provider storage;
executing the software of the virtualized container in the job execution environment;
capturing standard output and standard error streams from a command-line program being run in the job execution environment; and
forwarding the collected information in real-time to a streaming or messaging server;
sending, via the streaming/messaging server, the collected information to a on a user computing device.

9. A cloud-based platform, comprising:
a network;
a user computing device communicatively coupled to the network;
a cloud-computing server communicatively coupled to the network, the cloud computing server configured to:
receive input from at least one user of the user computing device;
generate, based on the received input, a virtualized container, wherein the virtualized container includes software and data;
execute the software of the virtualized container in a job execution environment;
receive, in response to execution of the software in the job execution environment, data output; and
publish, in response a directive from the at least one user, the data output.

10. The cloud-based platform of claim 9, wherein the input received from the at least one user via a command-line utility of the user computing device.

11. The cloud-based platform of claim 9, wherein the input received from the at least one user via a graphical user interface of the user computing device.

12. The cloud-based platform of claim 9, wherein the directive is provided by the at least one user via a command-line utility of the user computing device.

13. The cloud-based platform of claim 9, wherein the directive is provided by the at least one user via a graphical user interface of the user computing device.

14. A non-transitory computer readable medium comprising instructions that when executed by a processor implement:
causing to display at least one input interface to a user;
receiving input from the user via the at least one input interface;
generating a virtualized container, including software and data, based on the input received from the user;
transmitting the virtualized container to one or more APIs of a cloud platform backend;
receiving collected information from the one or more APIs of the cloud platform backend based on results generated by one or more cloud provider compute nodes of the cloud platform backend; and
causing to display the collected information to the user.

15. The non-transitory computer readable medium of claim 14, wherein the at least one input interface comprises a command-line utility.

16. The non-transitory computer readable medium of claim 14, wherein the at least one input interface comprises a graphical user interface.

17. The non-transitory computer readable medium of claim 14, wherein the collected information is caused to be displayed in a graphic web interface.

18. A non-transitory computer readable medium comprising instructions that when executed by a processor implement:
receiving, at one or more APIs from at least one user computing device, a virtualized container, wherein the virtualized container includes software and data;
deploying the virtualized container to a job execution environment, wherein the job execution environment includes one or more cloud provider compute nodes and cloud provider storage;
executing the software and data of the virtualized container in the job execution environment;
capturing standard output and standard error streams from a command-line program being run in the job execution environment; and
forwarding the standard output and standard error streams in real-time to the at least one user computing device via a streaming or messaging server.

19. The non-transitory computer readable medium of claim 18, wherein the instructions further implement:
selecting, based on the software and data of the virtualized container, a virtual machine type and hardware suited to run the software and data of the virtualized container.

20. The non-transitory computer readable medium of claim 18, wherein the results of the execution of the software and data in the job execution environment are published to one or more devices in response to a one-touch publishing command issued by the at least one user computing device.
